(19) United States
(12) Patent Application Publication
(10) Pub. No.: US 2008/0020663 A9
(43) Pub. Date: Jan. 24, 2008

(54) Laminated sheet material

(76) Inventor: William D. Walters, Byron, CA (US)

Correspondence Address: BEESON SKINNER BEVERLY LLP, ONE KAISER PLAZA, SUITE 750, OAKLAND, CA, 94612, US

(21) Appl. No.: 11/378,592

(22) Filed: Mar. 16, 2006

Related U.S. Application Data
(60) Provisional application No. 60/662,629, filed on Mar. 16, 2005.

(51) Int. Cl. B32B 5/18; B32B 5/22

(52) U.S. Cl. 442/76; 442/64; 442/66; 442/71; 442/104; 442/164

(57) ABSTRACT

A laminated sheet material comprises an insulating layer having a high thermal coefficient and efficient hydrophobic properties, a wicker layer adjacent the insulating layer having efficient hydrophilic properties, an elastomeric layer adjacent the wicker layer which is substantially impermeable to moisture and has good elasticity. An adhesive having good elastic properties substantially continuously joins the insulating, wicker and elastomeric layers together and is breathable between the insulating and wicker layers. In an alternate embodiment a cosmetic layer is joined to the elastomeric layer.

### FIELD OF THE INVENTION

This invention relates generally to laminated fabrics, and in particular to a laminated fabric that is gas impermeable, insulated and stretchable.

### BACKGROUND

Laminated fabrics formed by joining discrete sheets of materials with different properties are well-known in the prior art. Fabrics are generally laminated from multiple layers to create a composite that exhibits a synergy of the characteristics derived from each layer. For example, elastic materials may be combined with a layer that is substantially gas impermeable to achieve a laminate that is substantially gas impermeable with good elasticity. However, it has proved difficult to combine an elastomeric layer with one or more textile fabric layers unless the fabric layers are puckered or gathered when the elastomeric layer is in a relaxed state. Material in a gathered state is impractical for fabric which will be subjected to rigorous conditions because it is stretchable only to the limits of the fabric and assumes a height which may restrict movement and reduce design options.

Similarly, it is known to combine an insulating layer with a layer having wind-breaking properties. Laminates have also been provided having excellent stretch characteristics that are breathable.

There remains a need for a fabric that has good stretch and recovery properties, good insulating characteristics, and which is also gas impermeable. Ideally, such a material would also be flat (not gathered) in its relaxed state and durable.

### SUMMARY OF THE INVENTION

A laminated fabric according to the invention comprises a composite consisting of four layers. An insulating layer provides excellent insulation, is highly breathable, has good hand properties, is durable, and has superior elastic qualities.

A wicker layer adjacent the insulating layer acts primarily as a wicker, picking up moisture transferred from the insulating layer. Preferably it is comprised of a synthetic fleece material which provides excellent additional insulation and is stretchable.

An elastomeric layer adjacent the wicker layer is highly impermeable to gases, yet retains good elastic behavior. The elastomeric layer preferably comprises an ether-based polyurethane elastomer.

Finally, a cosmetic layer adjacent the elastomeric layer provides cosmetic design options, affords additional protection for the elastomeric layer, and has excellent elastic characteristics.

Each of the layers is joined to the adjacent layer or layers using a polyurethane hot melt adhesive applied in a dot matrix pattern. Application of the adhesive in a dot matrix pattern allows formation of air pockets in the interstices between the points of adhesion, providing valuable added insulating qualities to the laminate. The polyurethane adhesive also is itself stretchable, allowing it to move when the adjacent laminate layers to which it is bonded move.

The laminated fabric is impermeable to gas, warm, dry against the skin, comfortable, stretchable, durable, flat in a relaxed (unstretched) state, and highly resistant to hydrolysis.

### BRIEF DESCRIPTION OF THE ILLUSTRATIONS

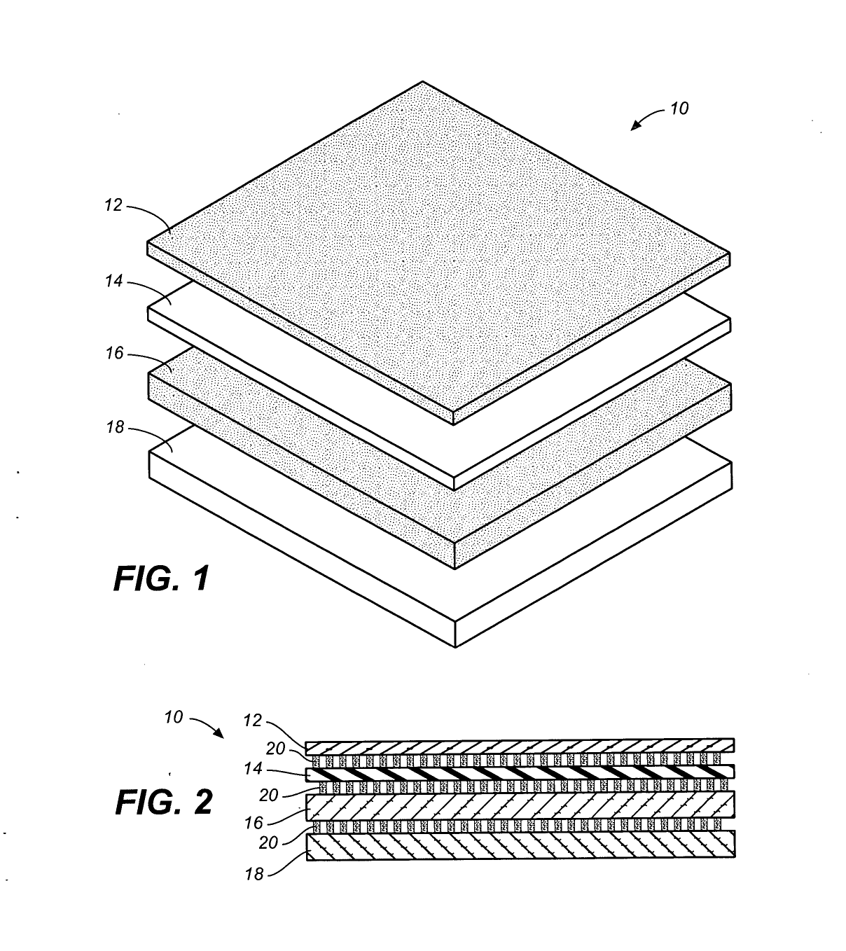

FIG. 1 is a perspective exploded view of the four layers of a preferred laminated fabric according to the invention.

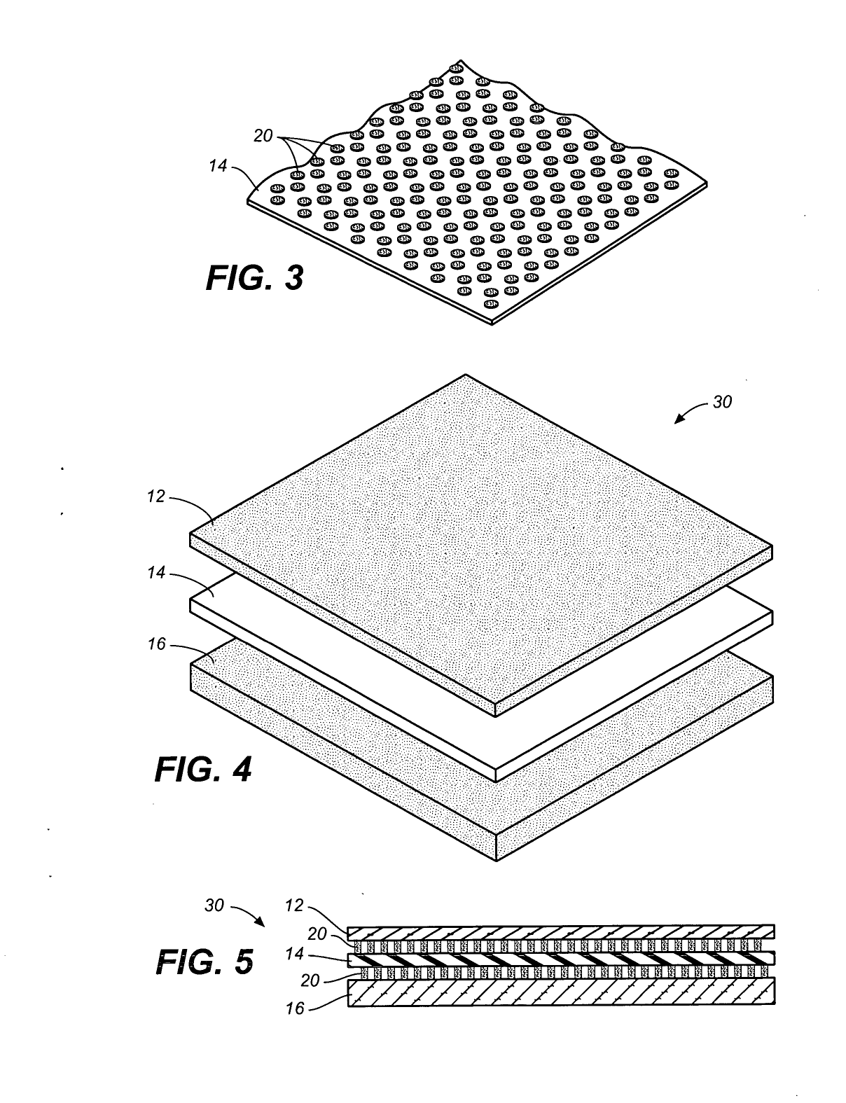

FIG. 2 is a side elevation view of a laminated fabric according to the invention.

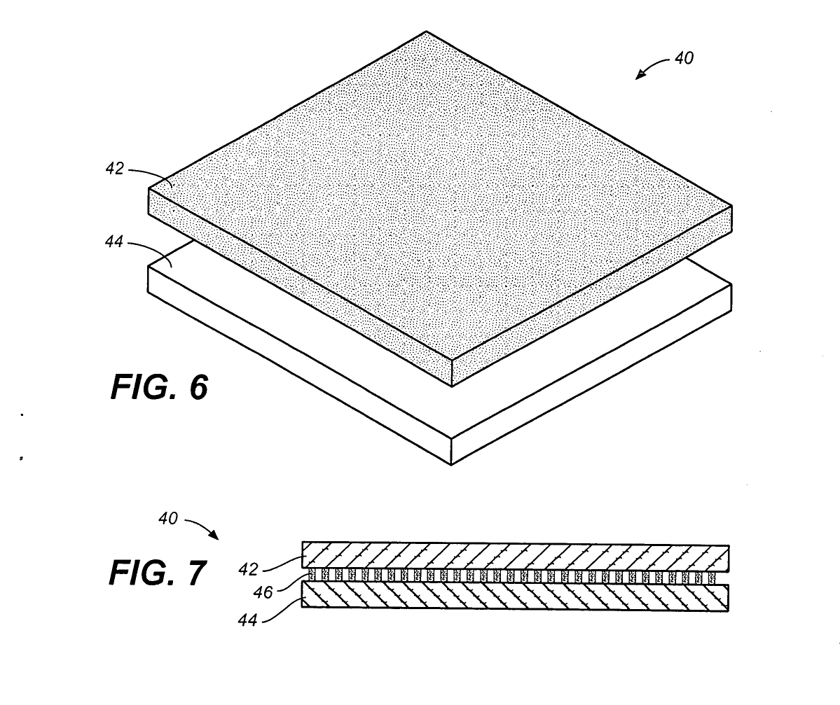

FIG. 3 is a perspective view of the wicker layer of the laminated fabric shown in FIG. 2 fully exposed to show the dot matrix pattern of the adhesive.

### DESCRIPTION OF THE PREFERRED EMBODIMENT

A laminated, impermeable, insulated, stretchable fabric 10 according to the invention comprises four layers: an insulating layer 12, a wicker layer 14, an elastomeric layer 16, and a cosmetic layer 18. See FIG. 1. Each layer is joined to its adjacent layer or layers by a stretchable adhesive 20 applied in a dot matrix pattern. See FIGS. 2 and 3.

In the preferred embodiment of the invention, the insulating layer 12 will be worn next to the skin. Therefore, it must be warm, comfortable, and breathable to moisture exuded from the wearer's body. In accordance with the invention, it must also have good elastic attributes. Materials suitable for the insulating layer include olefin sheets comprised of high density polyethylene or polyester fibers, nylon, and Kevlar® products. Preferably the insulating layer is composed of that fabric product identified as Style 1881C67F1 (the “7F1 fabric”) from Xymid, LLC, 220 GBC Drive, Newark, Del. 19702. The 7F1 fabric has good “hand” qualities making it comfortable to wear against the skin for extended periods, yet it is strong and highly puncture resistant exhibiting a toughness highly desired in challenging environments. High density polyethylene fiber fabrics like Xymid's 7F1 are breathable, allowing water vapor generated by the body to be transmitted away efficiently to the adjacent wicker layer. The 7F1 fabric also has a minimal absorption capacity of approximately one percent making it essentially hydrophobic. This is a significant advantage in the invention because so little of the water vapor generated by a person wearing the invention is retained in the insulating layer that it will be unnoticeable even after a full day's use.

The insulating layer 12 according to the invention is composed of cross-fibers which create air spaces. Applicants have determined that under normal atmospheric pressures the 7F1 fabric exhibits a thermal coefficient that is approximately 33% higher than any product having a comparable weight and thickness. The cross-fibers will initially compress under pressures such as are experienced during deep water diving conditions. However, after about sixty feet the nature of the bonds between the cross-fibers prevents their further compression and corresponding collapse of the air spaces. This is a significant advantage because the insulating qualities of the 7F1 fabric are preserved undiminished at depths below sixty feet.

Lastly, Xymid's 7F1 fabric also has very favorable two dimensional stretch coefficients of 200% in one direction and 160% in the other direction. Because it is stretchable, it need not be gathered when the laminate is in a relaxed state. This permits the laminate to be flat under all degrees of elongation.

Thus, Xymid's 7F1 fabric provides excellent insulating properties, is comfortable to wear, yet tough and durable, breathable, and stretchable. It will be readily appreciated by one of skill in the art that any high density polyethylene sheet material that is breathable, stretchable, and comfortable would be suitable for the insulating layer in the invention. Particularly appropriate are DuPont™ Sontara® spunlaced fabrics, available from the DuPont Corporation, DuPont Building, 1007 Market Street, Wilmington, Del. 19898, in which staple fibers are entangled in a “hydraulic needling” process to form a strong, nonwoven, fabric-like structure which is soft, strong and durable. Another option is Tyvek® fabrics, also available from DuPont, made from high density polyethylene fibers. Tyvek® fabrics are strong, lightweight, flexible, and smooth.

In a preferred embodiment of the invention, a wicker layer 14 is provided adjacent the insulating layer 12. The wicker and insulating layers are joined with an adhesive 20 discussed in greater detail below. In a preferred embodiment of the invention, the wicker layer is comprised of a synthetic fleece which is breathable and provides good insulation. An excellent selection of synthetic fleeces is available from the Malden Mills Industries, Inc., 1645 Solutions Center, Chicago, Ill. 60677 under the Polartec® Power Stretch® brands in a variety of thicknesses and weights. The Polartec® Power Stretch® fabrics are highly breathable and very effective at drawing off moisture vapor. Thus, the wicker layer efficiently absorbs water vapor transmitted through the insulating layer. Polartec® Power Stretch® fabrics are highly adept at wicking water vapor to the outside edge of the fabric where, under conditions where the fabric is exposed to the air, the water from the water vapor is quickly evaporated. In accordance with the invention, the wicker layer is joined to the elastomeric layer which, being impermeable, will prevent vapors reaching the back side of the wicker layer from evaporating. Under normal conditions of use of the invention the wicker layer will be cooler than the insulating layer. Therefore, water vapor migrating from the insulating layer into the wicker layer will condense and accumulate as water. Applicants have determined that a wicker layer of Polartec® Power Stretch® fabric of a thickness and volume equivalent to that which would be appropriate for inclusion in an average wet suit will hold up to a quart and a half of water. Under normal levels of exertion, this absorption capacity is well in excess of the water vapor which would be generated by one diving in such a suit.

The Polartec® Power Stretch® fabrics provide improved insulation without the weight and bulk of traditional fabrics. The insulating ability of Polartec® Power Stretch® fabrics is at its best when they are dry; their insulating capability diminishing as the material becomes saturated with water. However, the absorption capacity of the wicker layer is so much higher than the volume of water which it is anticipated would be generated during any single usage, that the insulating qualities of the wicker layer would be negligibly diminished. The combination of the wicker layer 14 adjacent the insulating layer 12 serves to maintain warmth adjacent the body while keeping the skin dry.

Polartec® Power Stretch® fabrics, as suggested by their brand name, also have good two-dimensional stretch qualities and excellent hydrolytic properties.

According to a preferred embodiment of the invention the elastomeric layer 16 is disposed adjacent the wicker layer 14. The elastomeric layer is joined to the wicker layer with an adhesive 20 discussed in greater detail below. The primary function of the elastomeric layer is to provide good barrier properties to water and gases. It is known that polyester has good stretch properties, but its impermeability to gases diminishes undesirably as it is stretched. Nevertheless, in applications where stretch requirements are not stringent, polyester could comprise the elastomeric layer.

In the preferred embodiment the elastomeric layer is comprised of an ether-based polyurethane sheet. Polyurethane is a cross-linked high polymer material with good elastic behavior. A distinct advantage to polyurethane is that it has excellent impermeability to gases even when stretched. Although polyurethane cannot be stretched as much as polyester, its good elasticity combined with its excellent gas barrier properties, high tensile strength, excellent abrasion resistance, and ease of lamination, make it an ideal material for combination with the insulating and wicker layers to achieve the purposes of the invention. A suitable product for the elastomeric layer is Dureflex™ polyurethane film number PT6300 (“PT6300”), a polyether-type polyurethane film which can be obtained from Deerfield Urethane, Inc., P.O. Box 186, South Deerfield, Mass. 01373, in a preferred thickness of 8 mils. Duraflex™ films have a tensile strength of 4000-10000 (as measured in accordance with ASTM Method D-412), an ultimate elongation of 350-800 (as measured in accordance with ASTM Method D-412), and tear strength of 300-700 (as measured in accordance with ASTM Method D-624), providing excellent tensile strength, superior elongation, and good tear strength compared to other materials such as neoprene, natural rubber and low density polyethylene. Depending on the intended application, other polyether type polyurethane films may be employed in the invention. However, PT6300 has very high tensile strength at 8000, superior ultimate elongation of 650, and good elasticity (ratings assume a material thickness of 5 mils). Additionally, it has the significant advantage that it is gas impermeable under all hydrolysis pressures experienced under normal sport scuba diving depths.

The cosmetic layer 18, according to the invention, preferably comprises spandex fabric, a material that is comprised of a long-chain synthetic polymeric fiber. Soft and rubbery segments of polyester of polyether polyols allow spandex fibers to stretch up to 600% and then recover to their original shape. In addition to its excellent stretch properties, spandex fabric has good tensile strength, is light weight, holds colors, and has favorable hydrolytic stability. Spandex fabric is available from DuPont and an increasing number of other manufacturers. The cosmetic layer therefore provides additional protection for the elastomeric layer, enhanced cosmetics, and durability in wet conditions.

The cosmetic layer 18 is joined to the elastomeric layer 16 with an adhesive 20 discussed below.

In another embodiment of the invention, the cosmetic layer is eliminated, leaving the insulating 12, wicker 14 and elastomeric 16 layers. This embodiment retains most of the qualities of the four-layer preferred embodiment at the expense of cosmetic design options and a measure of protection for the elastomeric layer 16.

As shown in FIG. 2, each layer in the laminate is adhesively bonded to its adjacent layer. According to a preferred aspect of the invention, each pair of layers is joined using an adhesive 20 applied in a dot matrix pattern. See FIGS. 2 and 3. This results in three significant advantages. First, as adjacent materials stretch each point of adhesion separates from neighboring points, permitting the material in the layers interposed between the points to stretch unimpeded by the adhesive. Second, air spaces are formed between the points of adhesion. Accordingly, approximately fifty percent of the area between each pair of layers is occupied by air spaces thereby significantly enhancing the insular qualities of the laminate as a whole. Third, preserving spaces between points of adhesion promotes transfer of vapors from the insulating layer to the wicker layer.

In the preferred embodiment of the invention the adhesive is itself stretchable. A suitable adhesive is a polyurethane hot melt adhesive available from Forbo Adhesives, LLC, P.O. Box 110447, Research Triangle Park, NC 27709-0497, under its Swift® Products brand, identified as Ever-Lock® 2U222 (“2U222”). 2U222 is specifically formulated as a laminating adhesive for membranes. In addition to being stretchable, 2U222 exhibits excellent hydrolytic stability and wash resistance.

In tests by applicant, samples of the preferred embodiment have exhibited a stretch capacity in the length dimension of up to 79%, averaging 70%, and in the width dimension of up to 100%, averaging 94.5%.

I claim:

1. A laminated sheet material comprising:
an insulating layer having a high thermal coefficient and efficient hydrophobic properties,
a wicker layer having efficient hydrophilic properties,
an elastomeric layer substantially impermeable to moisture, and
an adhesive for substantially continuously joining together said insulating, wicker and elastomeric layers.

2. The laminated sheet material of claim 1 further comprising:
a lengthwise dimension, and
an elongation capacity along said lengthwise dimension of up to approximately 70 to 79%.

3. The laminated sheet material of claim 1 further comprising:
a widthwise dimension, and
an elongation capacity along said widthwise dimension of up to approximately 94 to 100%.

4. The laminated sheet material of claim 1 wherein:
said insulating layer has a moisture absorption capacity of no greater than approximately one percent.

5. The laminated sheet material of claim 1 wherein:
said insulating layer is comprised of high density polyethylene fibers.

6. The laminated sheet material of claim 5 wherein:
said insulating layer has a Clo factor of approximately 0.18 at one atmosphere.

7. The laminated sheet material of claim 5 wherein:
said insulating layer has a Clo factor which does not substantially diminish under water pressures from approximately 60 psi to approximately 150 psi.

8. The laminated sheet material of claim 1 wherein:
said insulating layer has an elongation capacity of 200% in a first direction and 160% in a second direction perpendicular to the first direction.

9. The laminated sheet material of claim 1 wherein:
said wicker layer in adjacent disposition to said insulating layer, and
approximately 3.2 yards of said wicker layer is capable of absorbing up to between approximately one to one and one-half quarts of water.

10. The laminated sheet material of claim 1 wherein:
said wicker layer is breathable to moisture, has a Clo factor when dry of approximately 0.35 and, an elongation capacity of at least 200%.

11. The laminated sheet material of claim 10 wherein:
said wicker layer is comprised of a synthetic fleece.

12. The laminated sheet material of claim 1 wherein:
said elastomeric layer in adjacent disposition to said wicker layer.

13. The laminated sheet material of claim 1 wherein:
said elastomeric layer at a thickness of 5 mils having an elongation capacity of approximately 650%.

14. The laminated sheet material of claim 13 wherein:
said elastomeric layer is comprised of an ether-based polyurethane film, at a thickness of 5 mils said film having tensile strength of approximately 8000 psi and tear strength of approximately 375 pli,
said elastomeric layer having a thickness of 8 mils.

15. The laminated sheet material of claim 1 wherein:
said adhesive forms an adhesive layer in a dot matrix pattern between adjacent pairs of the insulating, wicker and elastomeric layers.

16. The laminated sheet material of claim 15 further comprising:
a first adhesive layer between said insulating and wicker layers, said first adhesive layer breathable to moisture.

17. The laminated sheet material of claim 15 further comprising:
said dot matrix pattern forming a plurality of dots of adhesive, each said dot spaced from the other dots in said pattern, and
air spaces formed between said dots.

18. The laminated sheet material of claim 15 wherein:
said adhesive has an elongation capacity of up to approximately 500% and tensile strength of approximately 3,400 psi.

19. The laminated sheet material of claim 1 further comprising:
a lengthwise dimension,
a widthwise dimension, and
an elongation capacity along said lengthwise dimension of up to approximately 70 to 79% and along said widthwise dimension of up to approximately 94 to 100%,
wherein each said layer remains ungathered through all degrees of elongation.

20. The laminated sheet material of claim 1 further comprising:
a cosmetic layer joined to said elastomeric layer, said cosmetic layer having an elongation capacity of up to approximately 600%, and
wherein said adhesive forms an adhesive layer between said elastomeric and cosmetic layers in a dot matrix pattern.

21. The laminated sheet material of claim 20 wherein:
said cosmetic layer has an elongation capacity of at least 200%, has good tensile strength, is light weight, holds colors, and has favorable hydrolytic stability.

22. The laminated sheet material of claim 20 wherein:
said cosmetic layer is comprised of spandex.

23. A laminated sheet material comprising:
an insulating layer having a Clo factor of approximately 0.18 at one atmosphere and efficient hydrophobic properties,
a wicker layer in adjacent disposition to said insulating layer, said wicker layer capable of absorbing up to between approximately one to one and one-half quarts of water
an elastomeric layer in adjacent disposition to said wicker layer, said elastomeric layer substantially impermeable to moisture, and at a thickness of 5 mils having an elongation capacity of approximately 650%, tensile strength of approximately 8000 psi, and tear strength of approximately 375 pli, and
an adhesive for substantially continuously joining together said insulating, wicker and elastomeric layers, said adhesive forming an adhesive layer in a dot matrix pattern between said insulating and wicker layers, said adhesive layer breathable to moisture, and said adhesive having an elongation capacity of up to approximately 500% and tensile strength of approximately 3,400 psi,
a lengthwise dimension,
a widthwise dimension, and
an elongation capacity along said lengthwise dimension of up to approximately 70 to 79% and along said widthwise dimension of up to approximately 94 to 100%.

24. The laminated sheet material of claim 23 further comprising:
a cosmetic layer joined to said elastomeric layer, said cosmetic layer having an elongation capacity of at least approximately 200%, and
wherein said adhesive forms an adhesive layer between said elastomeric and cosmetic layers in a dot matrix pattern.

25. The laminated sheet material of claim 24 wherein:
said cosmetic layer is comprised of spandex.

26. A laminated sheet material comprising:
an insulating layer comprised of high density polyethylene fibers, said insulating layer having a Clo factor of approximately 0.18 at one atmosphere and a moisture absorption capacity of no greater than approximately one percent,
a wicker layer in adjacent disposition to said insulating layer, said wicker layer comprised of synthetic fleece, capable of absorbing up to between approximately one to one and one-half quarts of water, has a Clo factor when dry of approximately 0.35 and, has an elongation capacity of at least 200%,
an elastomeric layer in adjacent disposition to said wicker layer, said elastomeric layer substantially impermeable to moisture, and at a thickness of 5 mils having an elongation capacity of approximately 650%, tensile strength of approximately 8000 psi, and tear strength of approximately 375 pli, said elastomeric layer having a thickness of 8 mils, and
an adhesive for substantially continuously joining together said insulating, wicker and elastomeric layers, said adhesive having an elongation capacity of up to approximately 500% and tensile strength of approximately 3,400 psi, said adhesive forming a first adhesive layer between said insulating and wicker layers and a second adhesive layer between said wicker and elastomeric layers, said first adhesive layer breathable to moisture, said first and second adhesive layers each forming a dot matrix pattern, and
a lengthwise dimension,
a widthwise dimension, and
an elongation capacity along said lengthwise dimension of up to approximately 70 to 79% and along said widthwise dimension of up to approximately 94 to 100%.

27. The laminated sheet material of claim 26 further comprising:
a cosmetic layer joined to said elastomeric layer, said cosmetic layer comprised of spandex having an elongation capacity of up to approximately 600%, has good tensile strength, is light weight, holds colors, and has favorable hydrolytic stability, and
wherein said adhesive forms an adhesive layer between said elastomeric and cosmetic layers in a dot matrix pattern.

28. A laminated sheet material comprising:
an elastomeric layer having an elongation capacity of approximately 400%, said elastomeric layer substantially impermeable to moisture through all degrees of said elongation capacity,
a cosmetic layer joined to said elastomeric layer, said cosmetic layer having an elongation capacity of at least 200%, and
an adhesive for substantially continuously joining together said elastomeric and cosmetic layers.

29. The laminated sheet material of claim 28 wherein:
said elastomeric layer is comprised of a polyether film having a thickness of 7 mils.

30. The laminated sheet material of claim 29 wherein:
said adhesive forms a dot matrix pattern between the elastomeric and cosmetic layers, and said adhesive has an elongation capacity of up to approximately 500%.
